(19) United States
(12) Patent Application Publication
(10) Pub. No.: US 2007/0206664 A1
(43) Pub. Date: Sep. 6, 2007

(54) Communication method and apparatus for multi-user detection

(76) Inventor: Alexander Grant, Mawson Lakes (AU)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 10/560,927

(22) PCT Filed: Jul. 29, 2003
(86) PCT No.: PCT/GB03/03288

§ 371 Date: Nov. 10, 2006

(30) Foreign Application Priority Data
Jun. 16, 2003 (GB) 0313904.5

(51) Int. Cl. H04B 1/00

(52) U.S. Cl. 375/148

(57) ABSTRACT

In a multi-user detection receiver, a multi-user detector DET receives a signal from a multiple access channel MA and the current soft estimates of each user's contribution to the received signal, and outputs updated soft estimates for each user by subtracting the current soft estimates of all the interfering users. The updated soft estimate or soft demodulated by soft demodulators DEM₁ . . . DEM_{K}, the coded by soft decoders DEC₁ . . . DEC_{K} which refine the probabilities of the coded bits derived from the soft demodulators DEM₁ . . . DEM_{K}, by taking into account the knowledge of the code, and output to soft modulators M₁ . . . M_{K}. For each iteration of the MUD receiver algorithm, an acquisition function ACQ acquires the timing of the estimates of each user's contribution to the channel for use by the detector DET in the next iteration, giving improved acquisition performance over conventional single-user techniques.

### FIELD OF THE INVENTION

The present invention relates to a method, apparatus and computer program for the iterative acquisition of signals for multi-user detection and decoding.

### BACKGROUND

Multi-user detection and decoding (MUD) techniques allow detection and decoding of transmissions by two or more mutually interfering users over an interference channel.

In general, MUD involves a detection process in which the received composite signal is resolved into symbol estimates for each user, and a decoding process in which the symbols are decoded to recover their data content, using a forward error correction (FEC) decoding algorithm. An optimal joint decoder combines these two processes using a maximum likelihood decoding technique to minimize the probability of decoder error. This technique has a complexity that increases exponentially with the number of users and the FEC codeword length, and may not be possible with certain FEC coding techniques such as Turbo codes. Hence, it is necessary to devise sub-optimal techniques with reduced complexity.

One sub-optimal approach is to separate the detection and decoding processes. Joint decisions are made on each symbol in the detection process, and the symbol streams are then independently decoded using conventional decoding techniques.

Another approach is iterative decoding, where soft decisions by the detector are input to separate decoders for each user, and the soft decisions by the decoders are fed back iteratively to the detector. Examples of iterative decoding algorithms are disclosed in ‘An Iterative Multiuser Decoder for Near-Capacity Communications’, Moher M, IEEE Transactions on Communications vol. 46, No. 7, July 1998 and ‘Multiuser Decoding for Multibeam systems’, Moher M, IEEE Transactions on Vehicular Technology, July 2000, Volume 49, Number 4, pages 1226-1234.

Before detection and decoding can take place, the timing, frequency and phase offset of each transmission must be acquired. Timing acquisition is particularly important, because frequency and phase estimation depend on the correct timing being acquired. Moreover, if a signal cannot be acquired or is incorrectly acquired, it cannot be decoded.

### STATEMENT OF THE INVENTION

According to one aspect of the present invention, there is provided a method of iteratively acquiring the timings of a plurality of transmissions in a signal received over a multiple access interference channel, the method comprising: estimating the relative timings of each of the transmissions; separately soft demodulating, decoding and remodulating each of the transmissions to generate soft estimates of each of the transmissions; for each transmission, cancelling the soft estimates of the other ones of the transmissions to generate an updated estimate of that transmission, and estimating the relative timings of each of the updated estimates of the transmissions.

Other aspects of the present invention include a computer program for performing the method, and apparatus arranged to perform the method.

### BRIEF DESCRIPTION OF THE DRAWINGS

Specific embodiments of the present invention will now be described with reference to the accompanying drawings, in which:

FIG. 1 shows the format of a burst to be acquired in an embodiment of the invention;

FIG. 2 is a diagram of multiple transmitters transmitting bursts over a multiple access channel;

FIG. 3 is a schematic diagram of a multi-user detector and decoder with an acquisition function in an embodiment of the present invention;

FIG. 4 is a diagram of a differential detector for use in the acquisition function;

FIG. 5 is a diagram of a coherent detector for use in the acquisition function;

FIG. 6 is a graph illustrating acquisition performance in a first simulation of the embodiment;

FIG. 7 is a graph illustrating acquisition performance in a second simulation of the embodiment; and

FIG. 8 is a chart showing regions in which acquisition can be achieved in the embodiment.

### DETAILED DESCRIPTION OF THE EMBODIMENTS

Burst Format

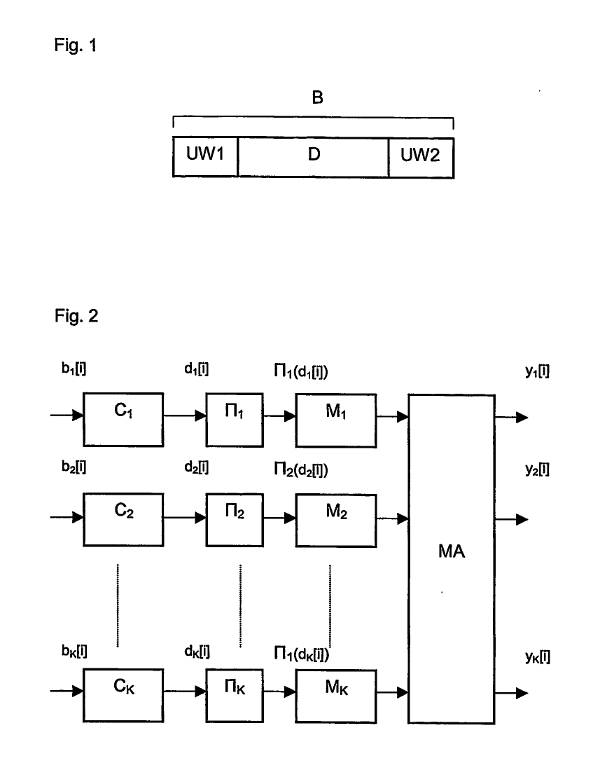

FIG. 1 shows one example of a format of transmitted bursts to be acquired in an embodiment of the present invention. The burst B comprises an initial unique word UW1, data D, and a final unique word UW2. The unique words are predetermined bit sequences, having low auto-correlation, which are known by a receiver and can therefore be used for burst acquisition. The presence of the final unique word UW2 is not essential, but use of both unique words improves acquisition performance.

The data D comprises a sequence of modulated symbols x[i], as will be described in more detail below.

A preamble or control word (not shown) may be transmitted before the initial unique word UW1, and a guard interval may be left between consecutive bursts in the same frequency channel.

As one specific example, the bursts B may be MESP5 or MESP20 packets complying with the Inmarsat™ MPDS (mobile packet data service) specification, as follows:

TABLE 1
MESP5 Packet Format

| | |
|---|---|
| Modulation | 16-QAM |
| Input bits per burst | 192 |
| Coding rate | 3/7 |
| Output bits per burst | 448 |
| Output symbols per burst | 112 |
| Preamble | 4 |
| Initial UW (symbols) | 20 |
| Final UW (symbols) | 20 |
| Total symbols/5 ms slot | 156 |
| Guard Time (symbols) | 12 |
| Symbol rate (ksps) | 33.6 |
| Slot length | 5 ms |

TABLE 2
MESP20 Packet Format

| | |
|---|---|
| Modulation | 16-QAM |
| Input bits per burst | 1192 |
| Coding rate | ½ |
| Output bits per burst | 2384 |
| Output symbols per burst | 596 |
| Preamble | 4 |
| Initial UW (symbols) | 40 |
| Final UW (symbols) | 20 |
| Total symbols/5 ms slot | 660 |
| Guard Time (symbols) | 12 |
| Symbol rate (ksps) | 33.6 |
| Slot length | 20 ms |

Transmitter

FIG. 2 shows a plurality K of users outputting respective bit sequences b₁[i] . . . b_{K}[i] encoded by encoders C₁ . . . C_{K} to produce coded sequences d₁[i] . . . d_{K}[i], which are interleaved by respective interleavers Π₁ . . . Π_{K} to generate interleaved sequences Π₁(d₁[i]) . . . Π_{K}(d_{K}[i]), which are in turn modulated by modulators M₁ . . . M_{K} to generate the respective sequences of modulated symbols x₁[i] . . . x_{K}[i] at time i. The modulated symbols are transmitted in bursts such as shown in FIG. 1. The data portion D preferably contains an integral number of blocks encoded by the encoders C₁ . . . C_{K}, and the encoders are reset after each block, so that the encoding of one burst is independent of the content of any other burst.

In one specific example, the encoders C₁ . . . C_{K} are Turbo encoders i.e. parallel systematic recursive convolutional encoders, one or more but not all of which have an interleaver at the input, as described for example in ‘Near Shannon limit error-correcting coding and decoding: Turbo codes’, Berrou, C., Glavieux, A. and Thitimajshima, P, Proc. of ICC '93, pp 1064-1070. The modulators M₁ . . . M_{K} may be 16 QAM modulators, as used for example in the Inmarsat™ MPDS.

Multiple Access Channel

The modulated symbol sequences x₁[i] . . . x_{K}[i] are transmitted on a multiple access channel MA such that a set of symbol sequences y₁[i] . . . y_{K}[i] are received at a receiver. The effect of the multiple access channel MA may be modelled as:
y[i]=AWx[i]+n[i] (1)

where y[i] is the complex vector channel output,

A is a normalised correlation matrix representing the cross-correlation between symbol sequences,

W is a diagonal matrix representing the amplitudes of each user and

n[i] represents the channel noise.

Receiver Architecture

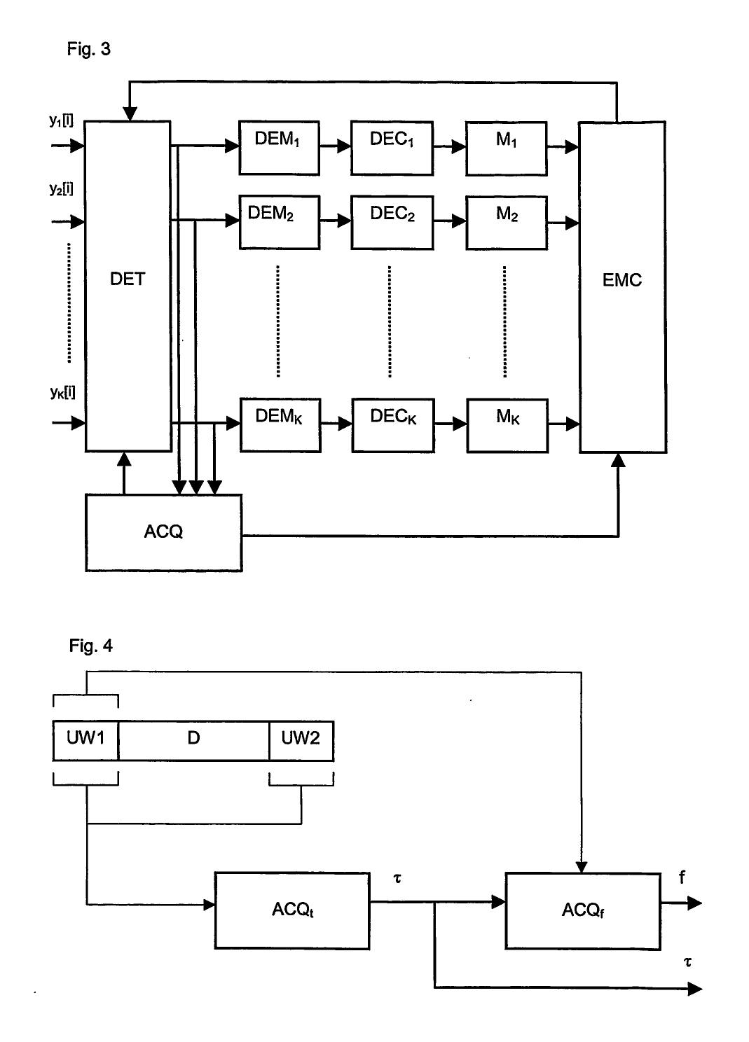

The received signal y₁[i] . . . y_{K}[i] is detected and decoded by an iterative MUD receiver as shown in FIG. 3. A multi-user detector DET takes as its input the output of the multiple access channel MA and the current soft estimates (initialised to zero at the first iteration) of each user's average contribution to the received signal, subject to the current probability distributions on the data. The detector DET outputs updated soft estimates for each user by subtracting the current soft estimates of all the interfering users.

The soft estimates for the respective users are soft demodulated by soft demodulators DEM₁ . . . DEM_{K}, which calculate the posterior probabilities of each possible symbol of the modulation constellation. For example, with a 16 QAM scheme, for each input symbol a probability is calculated of that symbol being each of the possible 16 symbols of the constellation. The corresponding soft detected bits are reordered by deinterleavers (not shown, for clarity) and input to soft decoders DEC₁ . . . DEC_{K} which refine the probabilities of the coded bits derived from the soft demodulators DEM₁ . . . DEM_{K} by taking into account the knowledge of the FEC code. The bits are reordered once again by respective interleavers (not shown) and output to soft modulators M₁ . . . M_{K}, which produce conditional expectations of the coded and modulated symbols according to the posterior probabilities calculated by the decoders DEC₁ . . . DEC_{K}. These average symbols are input to a model of an estimated multiple access channel EMA which updates the channel estimates for each user, on the basis of estimated channel parameters derived by an acquisition function ACQ, and feeds these back to the multi-user detector DET for the next iteration.

For each iteration of the MUD receiver algorithm, an acquisition function ACQ receives the estimates of each user's contribution to the channel from the multi-user detector DET and performs an acquisition algorithm, as will be described below, on each of the estimates. The time, frequency and phase detected for each of the users is output to the multi-user detector DET for use in the next iteration. At the first iteration, the multi-user detector DET has no knowledge of the users' contributions to the multiple access channel, so its outputs are simply equal to its inputs. The detected time, frequency and phase are also output to the estimated multiple access channel EMA.

Each user's contribution is identified by its acquired characteristics, such as timing and optionally frequency and phase, and each separate ‘arm’ of the MUD receiver operates on the updated soft estimate for a respective user with the acquired characteristics. As there are no current soft estimates during the first iteration of the MUD receiver, no cancellation is performed and each arm operates on the same received signal, but with the acquired characteristics of the respective user.

Provided that at least one user is acquired at the first iteration of the MUD receiver algorithm, the contribution of that user is subtracted from the contribution of the weaker users in subsequent iterations, thereby improving the likelihood of successful acquisition of the weaker users in subsequent iterations. Hence, the iterative acquisition technique is particularly suitable for acquiring weak users in the presence of interference from stronger users.

If a false acquisition of a user is made by the acquisition function ACQ, the following MUD iteration will attribute a low probability to the decoded signal from that user, which will lead to a very low weighting of that user's contribution by the multi-user detector DET. Hence, a false acquisition will have little effect on the acquisition and decoding of other users. In subsequent iterations, that user may be acquired correctly once the estimates of the other users have improved.

The MUD iterations are repeated, on the same received signal y1[i] . . . y_{K}[i], a number of times determined by the desired decoding performance and the acceptable processing delay. For example, the number of MUD iterations per received signal set may be fixed at a number likely to give the desired performance under most conditions. Alternatively, the MUD iterations may be repeated until the desired decoding accuracy is achieved for one or more of the users—this may be determined by the probabilities output by the soft decoders DEC1 . . . DECK exceeding a predetermined threshold—subject to a maximum number of iterations or maximum processing delay. The decoded bits for each user are then output by the MUD receiver.

The receiver architecture may be implemented in software, programmed for example into a digital signal processor (DSP) or other hardware or firmware, which may form part of a terminal. The functional blocks shown in FIG. 3 do not necessarily correspond to discrete hardware components.

Receiver Functional Description

Multi-user detector

The multi-user detector DET has the following inputs:
y[i] a sequence of complex K-vectors (for K users) received from the multiple access channel EMA
{ŷ₁[i], . . . ŷ_{K}[i]} a set of sequences of complex K-vectors from the estimated channel EMA

$$M [ i ] = [ \begin{matrix}{m [ i ]}_{1} \\ ⋮ \\ {m [ i ]}_{K}\end{matrix} ] \begin{matrix}a sequence of complex K \times K matrices . The row \\ vector {m [ i ]}_{k} is a filter to be used for user k .\end{matrix}$$

The multi-user detector DET has the following outputs:
\hat{x}[i] a sequence of complex K-vectors. The component \hat{x}ₖ[i] is the new estimate of symbol i for user k.
σₖ² estimated residual interference plus noise variance for user k.

The multi-user detector DET has the following operation:

For a synchronous channel,

$${\hat{x}}_{k} [ i ] = 〈 {m}_{k} [ i ] , ( y [ i ] - {\sum }_{j \neq k} {\hat{y}}_{j} [ i ] ) 〉 \qquad ( 2 )$$

This is the inner product between the filter for the user k and the results of cancelling all the estimated components other than user k from the channel output. For an asynchronous channel, each sequence \hat{x}ₖ[i] is delayed and equalised to compensate for symbol timing and frequency offset, as determined for example by the acquisition function ACQ.

The sequence of matrices M[i] represents a time-varying matrix filter. In the simplest case, this may be a diagonal matrix of complex values which representing gain and phase. These are assumed to be slowly varying and are estimated from unique words at the beginning and end of a burst.

The residual plus noise interference for each user is estimated from the completely cancelled signal:

$${\hat{n}}_{k} [ i ] = 〈 {m}_{k} [ i ] , ( y [ i ] - {\sum }_{j = 1}^{K} {\hat{y}}_{j} [ i ] ) 〉 \qquad ( 3 )$$

using a variance estimation technique:

$${σ}_{k}^{2} = \frac{1}{L - 1} {\sum }_{i = 1}^{L} {( {\hat{n}}_{k} [ i ] - \frac{1}{L} {\sum }_{j = 1}^{L} {\hat{n}}_{k} [ j ] )}^{2} \qquad ( 4 )$$

where L is the number of symbols in the bursts.

Soft Demodulator

Each soft demodulator DEMₖ has the following inputs:
\hat{x}ₖ[i] sequence of complex numbers corresponding. to the soft symbol estimates for user k
Q=(Q₀ . . . Q₁₅) An ordered set containing the normalised complex constellation values (assuming QAM, otherwise the cardinality will be different)
{S^{b}: b=0,1,2,3} A set containing the indices of the constellation points in Q that correspond to bit b being equal to zero.
(σ₁² . . . σ_{K}²) Noise plus residual interference estimates for each user

the following outputs:
(pₖ⁰[i],pₖ¹[i],pₖ²[i],pₖ³[i]) A sequence of 4vectors (in the case of QAM). Element pₖ^{b}[i] is the prior probability, between 0 and 1, that bit b of symbol i for user k is zero

and calculates the bit probabilities as follows:

$${p}_{k}^{b} [ i ] = {\sum }_{j ∈ {S}^{b}} η ( {\hat{x}}_{k} [ i ] - {Q}_{j} ) \qquad ( 5 )$$

where η is the zero mean, variance σₖ² Gaussian probability density function.

Channel Interleaver

Each channel interleaver and puncturer receives as input the data and parity bits from the corresponding coder Cₖ and interleaves and punctures them to generate sets of bits each corresponding to one symbol for modulation. This type of interleaver and puncturer is used in the Inmarsat™ IPDS. Each user uses the same interleaving and puncturing pattern.

Soft Decoder

Each soft decoder DECₖ has the following inputs:
N_{C} The number of decoding iterations to perform for each MUD iteration
Π_{k,CHANNEL} The channel interleaver for the user k
Π_{k,TURBO} The Turbo interleaver for the user k
(pₖ⁰[i],pₖ¹[i],pₖ²[i],pₖ³[i]) A sequence of 4vectors (in the case of QAM).

Element pₖ^{b}[i] is the prior probability, between 0 and 1, that bit b of symbol i for user k is zero
πₖ[i] A sequence of scalars representing the prior probability that bit i for user k is zero

and the following outputs:
(pₖ⁰[i],pₖ¹[i],pₖ²[i],pₖ³[i]) A sequence of 4vectors (in the case of QAM).

Element pₖ^{b}[i] is the posterior probability, between 0 and 1, that bit b of symbol i for user k is zero [i] A sequence of scalars representing the posterior probability that bit i for user k is zero

The posterior coded and uncoded bit probabilities are calculated from the prior coded and uncoded bit probabilities using an iterative “soft-in/soft-out” Turbo decoder. Techniques for iterative Turbo decoding are well-known in the art, for example: ‘Iterative Decoding of Binary Block and Convolutional Codes’, Hagenauer J, IEEE Transactions on Information Theory, Vol. 42, No. 2, March 1996.

Soft Modulator

Each soft modulator Mₖ has the following inputs:
Q=(Q₀ . . . Q₁₅) An ordered set containing the normalised complex constellation values (assuming QAM, otherwise the cardinality will be different)
{Bⱼ: j=0,1, . . . 15} A set containing the indices of the bits in j which are equal to zero. For example, B₀ is the set {0, 1, 2, 3} while B₅ is the set {1, 3}
(pₖ⁰[i],pₖ¹[i],pₖ²[i],pₖ³[i]) A sequence of 4-vectors (in the case of QAM). Element pₖ^{b}[i] is the posterior probability, between 0 and 1, that bit b of symbol i for user k is zero

and the following output:
\hat{x}[i] a sequence of complex scalars representing the new soft estimate of symbol i for user j

The estimates are calculated as the expectation of the signal constellation according to the current symbol probabilities:

$${\hat{x}}_{k} [ i ] = {\sum }_{j = 0}^{15} {Q}_{j} {P}_{j} \qquad ( 6 )$$

where the symbol probabilities are calculated according to

$${P}_{j} = [ {\prod }_{b ∈ {B}_{j}} {p}_{k}^{b} [ i ] ] [ {\prod }_{b ∈ {B}_{j}} ( 1 - {p}_{k}^{b} [ i ] ) ] \qquad ( 7 )$$

where B̅ⱼ is the complement set (i.e. the indices of the bits that are ones).

Acquisition Function

The acquisition function ACQ has the following input:
\hat{x}[i] a sequence of complex scalars. \hat{x}ₖ[i] represents the new soft estimate of symbol i for user k.

and outputs the current estimated channel parameters (phase, frequency, timing and amplitude). The acquisition function estimates the channel parameters for each of the sequences corresponding to the different users.

Estimated Multiple Access Channel

The estimated multiple access channel EMA has the following inputs:
\hat{x}[i] a sequence of complex scalars. \hat{x}ₖ[i] represents the new soft estimate of symbol i for user k
tₖ, fₖ, φₖ The current estimated channel parameters, including time, frequency and phase estimates for each user.

and the following outputs:
{ŷ₁[i], . . . ŷₖ[i]} a set of sequences of complex K-vectors. The vector sequence ŷₖ[i] corresponds to the current estimated contribution of user k to the channel output.

The estimated multiple access channel EMA models the effect of the actual multiple access channel according to the current estimates of the channel parameters. For example, if the channel is symbol synchronous,

$${\hat{y}}_{k} [ i ] = ( \begin{matrix}{\hat{w}}_{1 k} \\ {\hat{w}}_{2 k} \\ ⋮ \\ {\hat{w}}_{Kk}\end{matrix} ) {\hat{x}}_{k} [ i ] \qquad ( 8 )$$

where ŵⱼₖ is the estimated complex gain from user k to output j.

Acquisition Algorithms

Differential Detection

In one specific embodiment, a differential detection algorithm is used in the acquisition function ACQ. As represented in FIG. 4, the algorithm takes the initial and final unique words UW1 and UW2 of the relevant burst B as input and performs a time offset estimation ACQₜ. The estimated offset τ is then provided as input to a frequency estimation stage ACQ_{f} which calculates a frequency offset f using only the initial unique word UW1. The frequency estimation stage ACQ_{f} will not be described further.

In this algorithm, the time offset is detected by the use of differential correlation between the received burst and the reference value or values of the initial and final unique words UW1, UW2; this method is possible because of the low auto-correlation of the unique words.

The unique words UW1 and UW2 may be constant for all bursts, or may be selected from one of a plurality of possible unique words—this technique has various uses which will not be described here. In the latter case, correlation may be performed between the received burst and each of the possible reference unique words, and the reference unique word having the highest correlation peak is determined to correspond to the unique word present in the received burst.

First, the received signal y(t) is scalar multiplied by the conjugate of the reference unique word ŷ(t) with a test offset r which is varied between zero and the maximum time offset in steps of one sample period:
s(t)=y(t)·ŷ(t−τ) (9)

The power R₀ of the result is then calculated as follows:
R₀=s(t)×s′(t) (10)

where s′(t) is the transpose of s(t). Next, the differential power R₁ is calculated:
R₁=s(t−4T_{symbol}+Tₛₐₘₚₗₑ)×s′(t+Tₛₐₘₚₗₑ) (11)

where Tₛₐₘₚₗₑ is the sample interval of the receiver and T_{symbol} is the symbol period. For example, in a four times oversampling receiver, T_{symbol}=4×Tₛₐₘₚₗₑ.

The ratio of R₁ to R₀ is calculated for each value of τ and the value of τ which gives the highest ratio is taken as the best estimate of the time offset of the received burst.

The following pseudocode describes the differential detection algorithm:
Start Estimation

Remove guard and control word from received packet

FOR I=0; one sample steps; maximum offset
Scalar multiply received signal and conjugate of reference UW
Calculate the power of multiplication results
Calculate differential power of multiplication results
Calculate and record the ratio of the two powers and corresponding time offset
offset the reference UV by one sample

END FOR

Find maximum value of recorded power ratios

Return the time offset corresponding to maximum value End estimation

Differential detection has low complexity when detecting packets with large frequency offsets (e.g. >500 Hz). However, a performance gain may be expected by using a computationally more complex coherent detection algorithm, for example as described below.

Coherent Detection

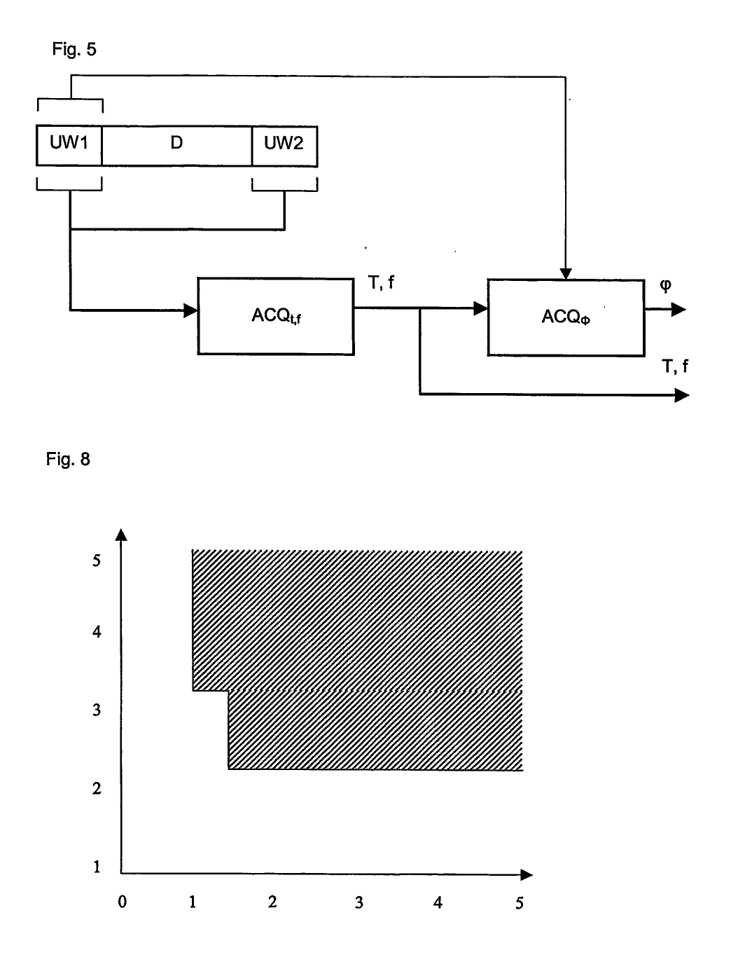

In an alternative embodiment, a coherent detection algorithm is used in the acquisition function ACQ. As represented in FIG. 5, the algorithm uses the initial and final unique words UW1 and UW2 of the relevant burst B to perform coherent estimation of both time and frequency offset ACQ_{t,f.}The estimated time offset τ and frequency offset are then used by a phase estimation stage ACQ_{φ} which calculates a phase offset φ using only the initial unique word UW1. The phase estimation stage ACQ_{φ} will not be described further.

First, the frequency offset is estimated by extracting two windows of data, with length corresponding to that of the initial unique word UW1, from respectively the beginning and end of the burst. The first window is correlated with the reference initial unique word UW1 and the second window with the reference final unique word UW2. The correlation of each window with the reference UW is modelled by:

$$\begin{matrix}r ( t ) = \hat{y} ( t - τ ) * y ( t ) \\ = {\int }_{- ∞}^{∞} \hat{y} ( λ - τ ) y ( λ - τ ) ⅆ λ\end{matrix} \qquad ( 12 )$$

where y(t) is the received signal, ŷ(t) is the reference UW and τ is the time offset applied in the current iteration, and which varies from zero to maximum offset in steps of one sample period of the receiver. The symbol ‘*’ denotes correlation.

The fast Fourier transforms (FFT) of the correlations are then taken and their magnitudes summed to yield a vector which is peak picked to find its maximum value. The FFT is calculated according to:

$$R ( k ) = \frac{1}{N} {\sum }_{n = 0}^{N - 1} x ( n ) {ⅇ}^{- j \frac{2 π n k}{N}} \qquad ( 13 )$$

where N is the number of samples, n is the discrete representation of time t, and k is the discrete representation of frequency ω.

The extraction is done in steps of one sample from zero to the maximum time offset. The frequency where the highest peak lies is taken as the estimated frequency offset. The sample index of the highest peak corresponds to the estimated time offset.

The following pseudocode describes the implementation of the coherent estimation algorithm:
Start of estimation

Remove guard and control word from received packet

FOR I=0; one sample steps; maximum offset
Correlate received signal with reference unique words
FFT the correlation result
Find and record highest FFT peak and its corresponding frequency
Offset the reference unique words by one sample END FOR

Find the maximum value among the recorded highest peaks

Return the time offset and frequency corresponding to the maximum value
End estimation

Optimal Multi-user Acquisition

Under high interference conditions, the single-user acquisition approaches described above (differential or coherent detection) may limit performance, and it may be preferable to use a multi-user acquisition algorithm. Such multi-user algorithms are generally too complex to evaluate in detail, but an outline of one possible approach is given below.

The following base band linear Gaussian signal model is assumed. K users transmit the same, known unique word x(t) to the receiver. The relative time offsets for the users are expressed as a vector τ=(τ₁, τ₂ . . . τ_{K}). For simplicity, the data portion D is ignored and it is assumed that the signal x(t) is zero outside the interval of the unique word. The vector of received signals:

$${y}_{i} ( t ) = {\sum }_{k = 1}^{K} {A}_{ik} x ( t - {τ}_{k} ) + {n}_{i} ( t ) \qquad ( 14 )$$

where Aᵢₖ is the gain from the k^{th} user's transmitter to spot beam i in a multiple spot beam satellite system; nᵢ(t) are circularly symmetric complex Gaussian noise with covariance E└nᵢ(t)nⱼ*(t+τ)┘=N₀ if both τ=0 and i=j, and zero otherwise. For simplicity, frequency and phase offset are assumed to be zero.

If the channel gains Aᵢₖ are unknown at the receiver, then an optimal maximum likelihood detector makes a joint decision on the gains and the delays τ₁, τ₂ . . . τ_{K}, according to:

$$\hat{A} , \hat{τ} = arg {max}_{A , τ} p ( y \text{\textbar} A , τ ) \qquad ( 15 )$$

Under the Gaussian assumption, choose the channel gains Â and delays \hat{τ} that minimize the Euclidean distance between the received signal y and the hypothesized signal ŷ, where:

$${\hat{y}}_{i} ( t ) = {\sum }_{k = 1}^{K} {\hat{A}}_{ik} x ( t - {\hat{τ}}_{k} ) \qquad ( 16 )$$

Thus the optimal detector operates according to:

$$\hat{A} , \hat{τ} = arg {max}_{\hat{A} , \hat{τ}} {\sum }_{i = 1}^{r} \int {\vert {y}_{i} ( t ) - {\hat{y}}_{i} ( t ) \vert}^{2} ⅆ t \qquad ( 17 )$$

If the channel gains are known, then only the delays are estimated, i.e. the maximization is only performed over τ. The maximal likelihood detector essentially performs maximal ratio combining on the received signals, involving searching all possible combinations of user delays; this is prohibitively complex with currently available hardware, although may become feasible with advances in processor power. If phase and frequency offsets are also present, then all possible combinations of delay, frequency and phase offsets for all users would have to be searched.

Hence, whilst it may be possible to perform multi-user acquisition, single-user techniques are preferred.

Acquisition Simulation Results

The effects of iterative acquisition using coherent detection were simulated in a two-user scenario. A ‘strong’ user has a carrier to interference ration C/I=10 dB and a ‘weak’ user is simulated using a range of smaller values of C/I. The thermal noise power E_{S}/N₀ is set the same for both users. Random user data D was created and encapsulated into bursts, with random timing offsets between 0 and 0.5 ms, but no frequency or phase offsets, since the the aim was to test timing acquisition performance only. The bursts were combined in a simulated multiple user channel and additive white Gaussian noise (AWGN) was added.

Tables 3 to 5 below show the results for simulation of 10,000 20 ms frames, after a first and a second iteration of the MUD algorithm, with the weak user C/I=1, 2 and 4 dB respectively.

TABLE 3
Weak User C/I = 1 dB

| | Strong User | Weak User Iteration 1 | Weak User Iteration 2 |
|---|---|---|---|
| Eₛ/N₀ | Errors | Errors | Errors |
| 0 | 1 | 3100 | 31 |
| 1 | 0 | 2110 | 0 |
| 3 | 0 | 1500 | 0 |
| 6 | 0 | 990 | 0 |

TABLE 4
Weak User C/I = 2 dB

| | Strong User | Weak User Iteration 1 | Weak User Iteration 2 |
|---|---|---|---|
| Eₛ/N₀ | Errors | Errors | Errors |
| 0 | 1 | 990 | 8 |
| 1 | 0 | 770 | 0 |
| 3 | 0 | 310 | 0 |
| 6 | 0 | 110 | 0 |

TABLE 5
Weak User C/I = 4 dB

| | Strong User | Weak User Iteration 1 | Weak User Iteration 2 |
|---|---|---|---|
| Eₛ/N₀ | Errors | Errors | Errors |
| 0 | 1 | 790 | 5 |
| 1 | 0 | 220 | 0 |
| 3 | 0 | 46 | 0 |
| 6 | 0 | 6 | 0 |

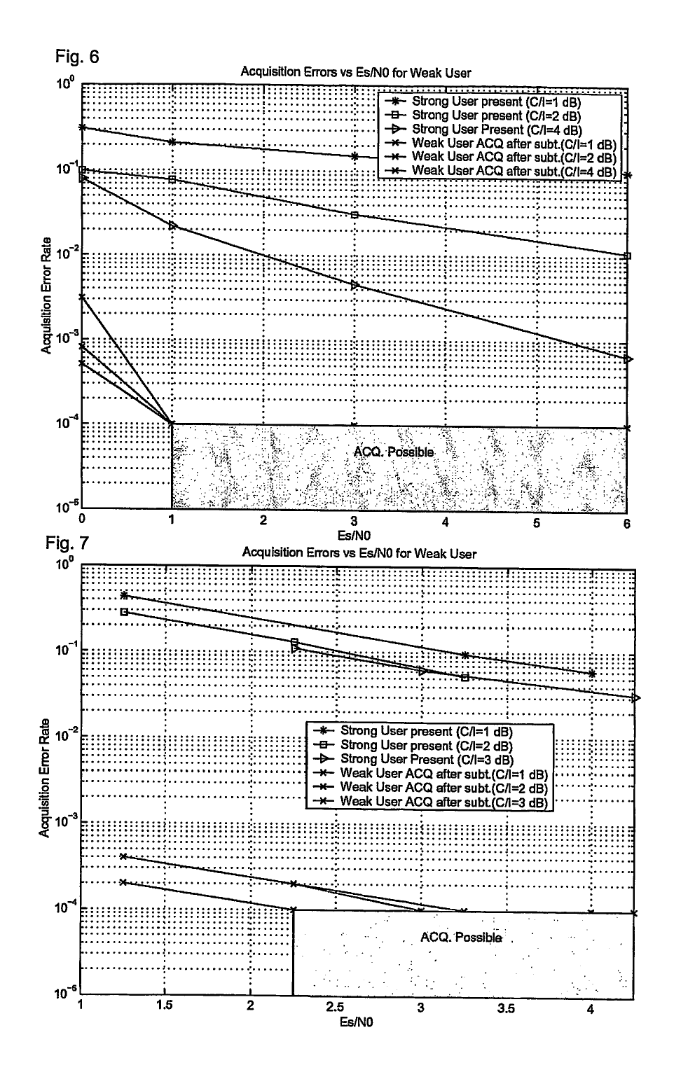

FIG. 6 shows the acquisition performance for the weak user before and after (shaded region) the strong user was subtracted. These results show that the iterative acquisition method can successfully acquire users that cannot be acquired by single-user non-iterative techniques. For E_{S}/N₀≧1 dB, the weak user can be acquired (error rate less than 10⁻⁴) using the iterative method.

A further simulation was performed using Inarsat™ IPDS bearer sub-type L3, which has a coding rate of ⅓, under fading conditions (C/M=15 dB, fading bandwidth 20 Hz, multipath delay=0). Otherwise, the parameters were the same as in the simulation above. The results are shown in Tables 6 to 8 below.

TABLE 6
Weak User C/I = 1 dB

| | Strong User | Weak User Iteration 1 | Weak User Iteration 2 |
|---|---|---|---|
| Eₛ/N₀ | Errors | Errors | Errors |
| 1.25 | 1 | 4360 | 4 |
| 2.25 | 0 | 960 | 0 |
| 3.25 | 0 | 600 | 0 |

TABLE 7
Weak User C/I = 2 dB

| | Strong User | Weak User Iteration 1 | Weak User Iteration 2 |
|---|---|---|---|
| Eₛ/N₀ | Errors | Errors | Errors |
| 1.25 | 0 | 2810 | 2 |
| 2.25 | 0 | 1300 | 0 |
| 3.25 | 0 | 525 | 0 |

TABLE 8
Weak User C/I = 4 dB

| | Strong User | Weak User Iteration 1 | Weak User Iteration 2 |
|---|---|---|---|
| Eₛ/N₀ | Errors | Errors | Errors |
| 1.25 | 1 | 1100 | 2 |
| 2.25 | 0 | 620 | 0 |
| 3.25 | 0 | 320 | 0 |

The results are shown in FIG. 7. Acquisition is again possible in regions where it would not be possible using single-user non-iterative techniques only. For E_{S}/N₀≧2.25, the weak user can be successfully acquired.

FIG. 8 shows the region in which the iterative acquisition method can be used successfully to acquire a weak user in the case where the strong user has C/I=10 dB. The horizontal axis represents the C/I for the weak user, while the vertical axis represents signal to noise ratio (E_{S}/N₀), which is common to both users. The shaded region above and to the right of the line represents the conditions where acquisition of the weak user is achievable with error rate less than 10⁻⁴. Hence, the iterative method greatly improves the acquisition performance for weaker users.

In summary, it has been demonstrated that the use of iterative acquisition techniques in combination with iterative decoding techniques gives superior performance to non-iterative initial acquisition techniques in a multi-user detector. The superior performance is due at least in part to the use of information derived by a decoding iteration to improve the performance of the next acquisition iteration. This advantage is not dependent on the specific details of the examples and simulations described above. Hence, the skilled person will recognise that the present invention is not limited save as defined in the following claims.

1. A method of estimating a timing of a first transmission received with a second transmission as a combined signal over a multiple access interference channel, comprising:
a. estimating the timing of the second transmission;
b. demodulating, decoding and remodulating the second transmission, on the basis of the estimated timing of the second transmission, to generate an estimate of the second transmission;
c. cancelling the estimate of the second transmission from the combined signal to generate an estimate of the first transmission; and
d. estimating the timing of the first transmission from the estimate of the first transmission.

2. The method of claim 1, wherein the cancelling of the estimate of the second transmission is weighted according to the probability of the estimate.

3. The method of claim 2, wherein the probability of the estimate is calculated using a soft decoding technique to decode the second transmission.

4. The method of claim 2, wherein the probability of the estimate is calculated using a soft demodulating technique to demodulate the second transmission.

5. The method of claims 1, further including:
e. demodulating, decoding and remodulating the first transmission, on the basis of the estimated timing of the first transmission, to generate an estimate of the first transmission;
f. cancelling the estimate of the first transmission from the combined signal to generate an estimate of the second transmission; and
g. estimating the timing of the second transmission from the estimate of the second transmission.

6. The method of claim 5, including repeating steps b to g so as to obtain improved estimates of the timings of the first and second transmissions.

7. The method of claim 5, wherein the combined signal includes one or more further transmissions.

8. The method of claim 7, wherein step a includes estimating the timing of the one or more further transmissions, step b includes demodulating, decoding and remodulating the one or more further transmissions, on the basis of the respective estimated timing of the one or more further transmissions, to generate an estimate of the one or more further transmissions, and step c includes cancelling the estimate of the one or more further transmissions from the combined signal to generate an estimate of the first transmission.

9. The method of claim 8, wherein step f includes cancelling the estimate of the one or more further transmissions from the combined signal to generate the estimate of the second transmission.

10. A method of estimating the timings of a plurality of transmissions received as a combined signal over a multiple access channel, comprising:
a. estimating the timings of each of the plurality of transmissions;
b. soft demodulating, soft decoding and soft remodulating current estimates of each of the plurality of transmissions, on the basis of their respective estimated timings, to generate soft estimates of each of the transmissions;
c. updating the current estimates of each of the transmissions by cancelling the soft estimates of the other transmissions from the combined signal;
d. estimating the timings of each of the transmissions from the respective current estimates of the transmissions; and
e. repeating steps b to e to obtain progressive estimates of the timings of each of the transmissions.

11. The method of claim 10, wherein steps a to e are repeated until a predetermined condition is satisfied.

12. The method of claim 11, including outputting the soft decoded current estimates.

13. The method of claim 10, wherein the timing estimating steps are performed using differential detection.

14. The method of claim 10, wherein the timing estimating steps are performed using coherent detection.

15. A computer program for performing the method of claim 10 when executed.

16. A computer program product storing a computer program according to claim 15.

17. Apparatus for estimating a timing of a first transmission received with a second transmission as a combined signal over a multiple access interference channel, the apparatus being arranged to:
a. estimate the timing of the second transmission;
b. demodulate, decode and remodulate the second transmission, on the basis of the estimated timing of the second transmission, to generate an estimate of the second transmission;
c. cancel the estimate of the second transmission from the combined signal to generate an estimate of the first transmission; and
d. estimate the timing of the first transmission from the estimate of the first transmission.

18. The apparatus of claim 17, wherein the cancelling of the estimate of the second transmission is weighted according to the probability of the estimate.

19. The apparatus of claim 18, wherein the probability of the estimate is calculated using a soft decoding technique to decode the second transmission.

20. The apparatus of claim 18, wherein the probability of the estimate is calculated using a soft demodulating technique to demodulate the second transmission.

21. The apparatus of claims 17, further arranged to:
e. demodulate, decode and remodulate the first transmission, on the basis of the estimated timing of the first transmission, to generate an estimate of the first transmission;
f. cancel the estimate of the first transmission from the combined signal to generate an estimate of the second transmission; and
g. estimate the timing of the second transmission from the estimate of the second transmission.

22. The apparatus of claim 21, further arranged to repeat steps b to g so as to obtain improved estimates of the timings of the first and second transmissions.

23. The apparatus of claim 21, wherein the combined signal includes one or more further transmissions.

24. The apparatus of claim 23, wherein step a includes estimating the timing of the one or more further transmissions, step b includes demodulating, decoding and remodulating the one or more further transmissions, to generate an estimate of the one or more further transmissions, and step c includes cancelling the estimate of the one or more further transmissions from the combined signal to generate an estimate of the first transmission.

25. The apparatus of claim 24, wherein step f includes cancelling the estimate of the one or more further transmissions from the combined signal to generate the estimate of the second transmission.

26. Apparatus for estimating the timings of a plurality of transmissions received as a combined signal over a multiple access channel, the apparatus being arranged to:
a. estimate the timings of each of the plurality of transmissions;
b. soft demodulate, soft decode and soft remodulate current estimates of each of the plurality of transmissions, on the basis of their respective estimated timings, to generate soft estimates of each of the transmissions;
c. update the current estimates of each of the transmissions by cancelling the soft estimates of the other transmissions from the combined signal;
d. estimate the timings of each of the transmissions from the respective current estimates of the transmissions; and
e. repeat steps b to e to obtain progressive estimates of the timings of each of the transmissions.

27. The apparatus of claim 26, wherein steps a to e are repeated until a predetermined condition is satisfied.

28. The apparatus of claim 27, including outputting the soft decoded current estimates.

29. The apparatus of claim 26, wherein the timing estimating steps are performed using differential detection.

30. The apparatus of claim 26, wherein the timing estimating steps are performed using coherent detection.
